(19) United States
(12) Patent Application Publication
(10) Pub. No.: US 2005/0144482 A1
(43) Pub. Date: Jun. 30, 2005

(54) Internet protocol compatible access authentication system

(76) Inventor: David Anuszewski, Pottstown, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/013,084

(22) Filed: Dec. 15, 2004

Related U.S. Application Data
(60) Provisional application No. 60/530,361, filed on Dec. 17, 2003.

(51) Int. Cl. H04L 9/00

(52) U.S. Cl. 713/201

(57) ABSTRACT

An Internet compatible system, for use in authenticating user access to information, includes a repository and an authentication processor. The repository associates an initial user identifier with a particular executable application and with credential information. The credential information includes a first user identifier and a corresponding first password, which enable user access to the particular executable application. The authentication processor receives data representing the initial user identifier. The authentication processor detects a browser application initiated request for credential information in response to a user command to the browser application to access a particular executable application. The authentication processor validates whether credential information derived from the repository, using the received initial user identifier, authorizes a user to access the particular executable application in response to a detected browser application initiated request. The authentication processor provides validated authorized credential information derived from the repository to the browser application to enable a user to access the particular executable application in response to successful validation.

### CROSS-REFERENCE TO RELATED APPLICATIONS

The present application is a non-provisional application of provisional application having Ser. No. 60/530,361 filed by David Anuszewski on Dec. 17, 2003.

### FIELD OF THE INVENTION

The present invention generally relates to computer information systems. More particularly, the present invention relates to an Internet protocol compatible access authentication system.

### BACKGROUND OF THE INVENTION

Computer security refers to techniques for ensuring that data stored in a computer system cannot be read or compromised without proper permission. Most computer security systems control access using authentication and/or authorization.

Authentication is a process of controlling access to a secure computer system by a computer, a computer program, or an individual. Authentication typically controls access to a multi-user secure computer system by identifying an individual by who they are (e.g., biometrics, such as finger print or retinal scan), what they have (e.g., identification card or radio frequency identification tag), or what they know (e.g., credentials, such as username and/or a password). One technique for authentication over the Internet is a process called hyper-text transfer protocol (HTTP) basic authentication, which includes a user name and a user password.

Authorization, by comparison, is a process of controlling an individual's right to access to system objects in the secure computer system. Typically, a secure computer system first authenticates and then authorizes an individual.

Some secure Internet-based computer systems use basic authentication, which require an individual to manually re-authenticate every time the individual accesses the same or different computer resource. However, manual re-authentication interrupts an individual's workflow, which is time consuming, and different computer resources may require different credentials, which can be confusing or difficult to remember.

Other secure Internet-based computer systems use basic authentication and a record/playback mechanism to automatically input the credentials for the individual to provide automatic re-authentication. The use of a record/playback mechanism requires capturing the credentials when entered by the individual, and delivering the credentials to the individual's computer to permit the credentials to be automatically inputted (i.e., scripted). However, the record/playback mechanism is subject to security problems and to availability on the individual's computer.

Other secure Internet-based computer systems replace basic authentication with a proprietary security mechanism with specific hooks for passing user context. However, proprietary security mechanisms are not compatible with industry standards or non-proprietary computer resources, and require significant development cost and effort.

Other secure Internet-based computer systems replace basic authentication with industry standard certificates. However, the certificates impose significant certificate management issues and expense because certificates need to be obtained and managed for each client computer.

Accordingly, there is a need for an Internet protocol compatible access authentication system that overcomes these and other disadvantages of the prior systems.

### SUMMARY OF THE INVENTION

An Internet compatible system, for use in authenticating user access to information, includes a repository and an authentication processor. The repository associates an initial user identifier with a particular executable application and with credential information. The credential information includes a first user identifier and a corresponding first password, which enable user access to the particular executable application. The authentication processor receives data representing the initial user identifier. The authentication processor detects a browser application initiated request for credential information in response to a user command to the browser application to access a particular executable application. The authentication processor validates whether credential information derived from the repository, using the received initial user identifier, authorizes a user to access the particular executable application in response to a detected browser application initiated request. The authentication processor provides validated authorized credential information derived from the repository to the browser application to enable a user to access the particular executable application in response to successful validation.

### BRIEF DESCRIPTION OF THE DRAWINGS

FIG. 1 illustrates an authentication system, in accordance with invention principles.

FIG. 2 illustrates a client and one server for the system, as shown in FIG. 1, in accordance with invention principles.

FIG. 3 illustrates an authentication method for the system, as shown in FIG. 1, in accordance with invention principles.

FIG. 4 illustrates a sequence diagram for first time user operation of the system, as shown in FIG. 1, in accordance with invention principles.

FIG. 5 illustrates a sequence diagram for normal operation of the system, as shown in FIG. 1, in accordance with invention principles.

FIG. 6 illustrates a sequence diagram for expired password operation of the system, as shown in FIG. 1, in accordance with invention principles.

FIG. 7 illustrates an authentication window for the system, as shown in FIG. 1, in accordance with invention principles.

### DETAILED DESCRIPTION OF THE PREFERRED EMBODIMENTS

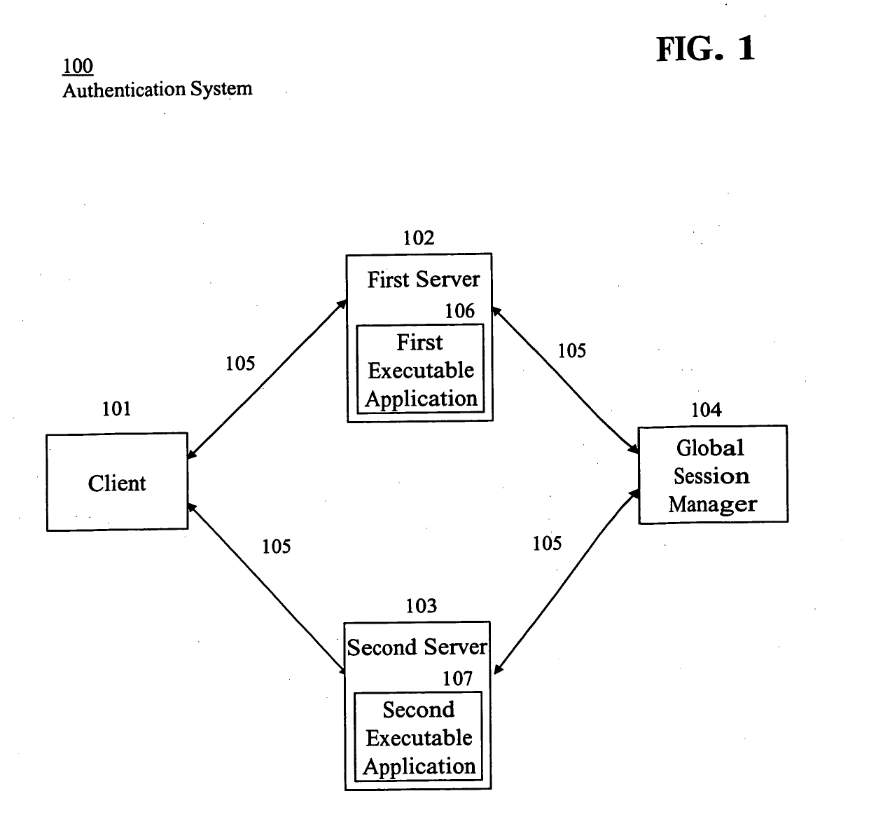

FIG. 1 illustrates an authentication system 100 (“system”). The system 100 includes a client 101, a first server 102, a second server 103, and a global session manager 104 (“manager”), interconnected to each other by a network 105. The first server 102 includes a first executable application 106 (“first application”). The second server 103 includes a second executable application 107 (“second application”). The system 100 may include any number of clients, servers, and managers, and each of the servers may include any number of executable applications. The applications may be deployed in-house or remotely.

The system 100 may be employed by any type of enterprise, organization, or department may employ the system 100, such as, for example, providers of healthcare products and/or services responsible for servicing the health and/or welfare of people in its care. For example, the system 100 represents a hospital information system. A healthcare provider may provide services directed to the mental, emotional, or physical well being of a patient. Examples of healthcare providers include a hospital, a nursing home, an assisted living care arrangement, a home health care arrangement, a hospice arrangement, a critical care arrangement, a health care clinic, a physical therapy clinic, a chiropractic clinic, a medical supplier, a pharmacy, and a dental office. When servicing a person in its care, a healthcare provider diagnoses a condition or disease, and recommends a course of treatment to cure the condition, if such treatment exists, or provides preventative healthcare services. Examples of the people being serviced by a healthcare provider include a patient, a resident, a client, and an individual.

Each of the elements in the system 100 may be fixed and/or mobile (i.e., portable), and may be implemented in a variety of forms including, but not limited to, one or more of the following: a personal computer (PC), a desktop computer, a laptop computer, a workstation, a minicomputer, a mainframe, a supercomputer, a network-based device, a personal digital assistant (PDA), a smart card, a cellular telephone, a pager, and a wristwatch. The system 100 may be implemented in a centralized or decentralized configuration.

In the system 100, one or more elements may be implemented in hardware, software, or a combination of both, and may include one or more processors. A processor is a device and/or set of machine-readable instructions for performing task. A processor includes any combination of hardware, firmware, and/or software. A processor acts upon stored and/or received information by computing, manipulating, analyzing, modifying, converting, or transmitting information for use by an executable procedure or an information device, and/or by routing the information to an output device. For example, a processor may use or include the capabilities of a controller or microprocessor.

The network 105 (otherwise called a communication path or link) may use any type of protocol or data format including, but not limited to, the following: an Internet Protocol (IP), a Transmission Control Protocol Internet protocol (TCPIP), a Hyper Text Transmission Protocol (HTTP), an RS232 protocol, an Ethernet protocol, a Medical Interface Bus (MIB) compatible protocol, a Local Area Network (LAN) protocol, a Wide Area Network (WAN) protocol, a Campus Area Network (CAN) protocol, a Metropolitan Area Network (MAN) protocol, a Home Area Network (HAN) protocol, an Institute Of Electrical And Electronic Engineers (IEEE) bus compatible protocol, a Digital and Imaging Communications (DICOM) protocol, and a Health Level Seven (HL7) protocol.

The system 100 employs client/server architecture. Client/server architecture is a distributed, computational architecture that involves client processes and/or devices requesting service from server processes and/or devices. The client 101 is a computer or device on the network 105, such as a personal computer or a workstation, on which user's run applications. A server 102 or 103 is a computer or device on the network 105 that manages network resources, such as disk drives, printers, network traffic, databases, and processing power. Servers may be dedicated to executing a single task or several tasks at the same time.

The global session manager 104 coordinates the sessions for the first server 102 and the second server 103. The manager 104 may be represented as a separate element, as shown in FIG. 1, or may be incorporated into one or more of the servers 102 and 103. A session is the period of time a user interfaces with one or more applications. The session begins when the user accesses the application and ends when the user quits the application. The session is the activity that a user spends on a Web site during a specified time. The number of user sessions on a site is used in measuring the amount of traffic a Web site gets. The site administrator determines what the time duration of a user session will be (e.g., 30 minutes), without any user activity. If the visitor is active on the site within that time, it is still considered one user session because any number of visits within the 30 minutes is only count as one session. If the visitor returns to the site after the allotted time has expired due to no user activity, such as an hour from the initial visit, then it is counted as a separate user session.

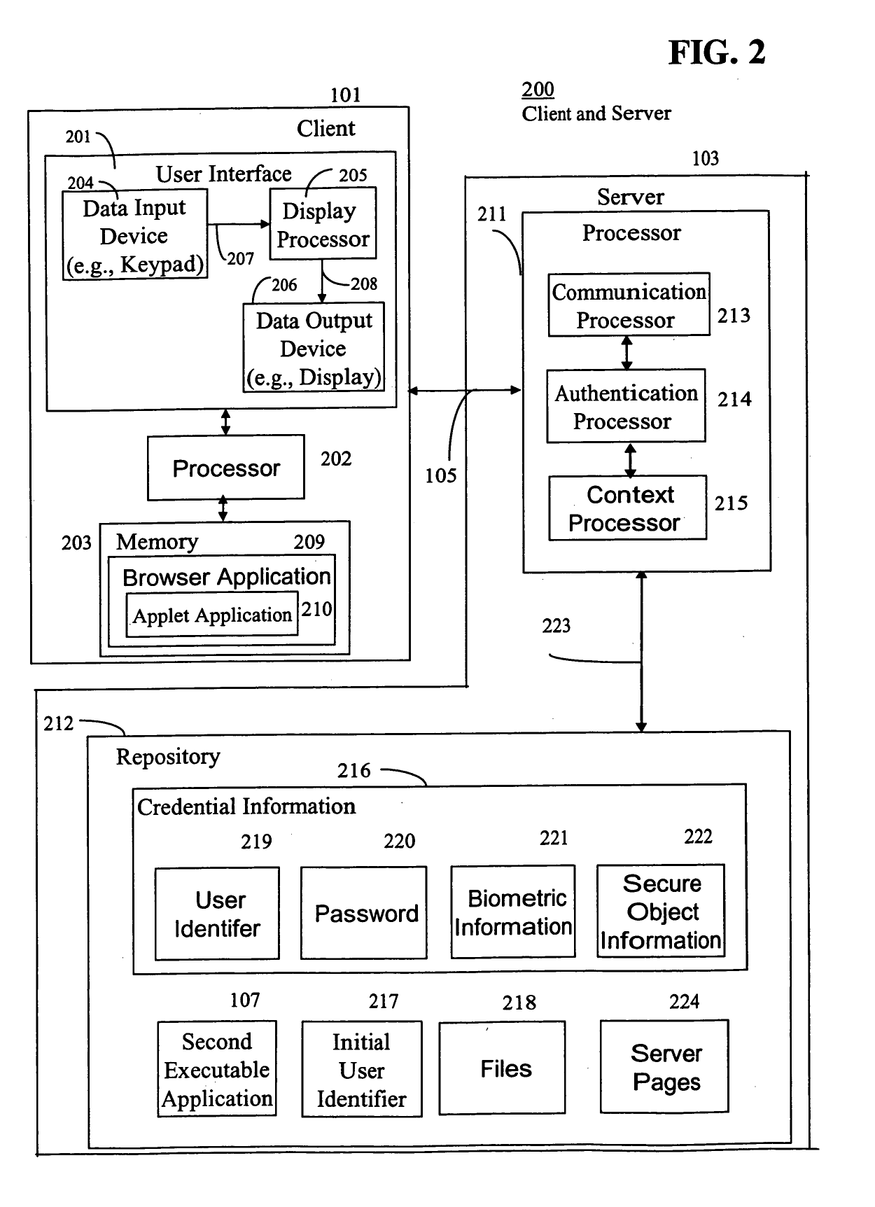

The system 100 supports a process called single sign on (also spelled single sign on or single sign-on and abbreviated as SSO). Single sign on is an authentication process in a client/server architecture where the user, via the client 101, performs a one-time entry of credential information 216 (see FIG. 2), such as a user identifier 219 and a password 220, to access to more than one application, or to obtain access to a number of resources within the system 100. Single sign on removes the need for the user to enter the same or additional credential information when switching from one application to another, and allows a task sequence workflow to continue without interruption. The different applications requiring sign on may be implemented on the same server or on different servers. For example, the user, via the client 101, enters credential information a single time to access the first application 106 on the first server 102 and to access the second application 107 on the second server 103.

The single sign on process provides at least the following advantages:
1. Allows resources to be secured by HTTP basic authentication.
2. Allows resources to utilize infrastructure that works using HTTP basic authentication.
3. Enables required components, other than an Internet Browser, to be downloaded to the client 101 on demand via HTTP requests.
4. Does not require separate software to capture credential information.
5. Secures the management and delivery of credentials.
6. Does not require expensive certificate management processes/solutions.
7. Does not require HTTP server side cookies

FIG. 2 illustrates the client 101 and the second server 103 for the system 100, as shown in FIG. 1. The client 101 communicates with the second server 103 over the network 105.

The client 101 includes a user interface 201, a processor 202, and a memory 203. The user interface 201 includes a data input device 204, a display processor 205, and a data output device 206. The memory 203 includes a browser application 209 (“browser”), wherein the browser application 209 includes an applet application 210 (“applet”). The processor 202 communicates with each of the user interface 201 and the memory 203.

The server 103 includes a processor 211 and a repository 212. The processor 211 includes a communication processor 213, an authentication processor 214, and a context processor 215. The repository 212 includes credential information 216, the second application 107, an initial user identifier 217, files 218, and server pages 224. The credential information 216 includes a user identifier 219, a password 220, biometric information 221, and secure object information 222. The server 102 contains the same elements as the server 103.

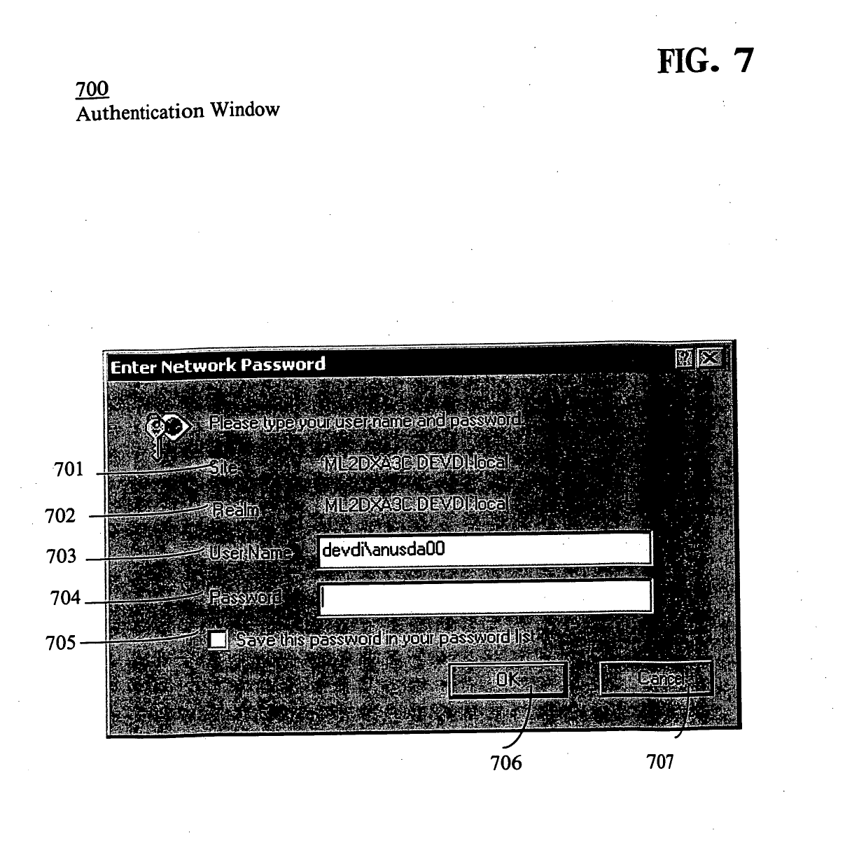

In the client 101, the user interface 201 permits a user to interact with the client 101 by inputting user interface data 207 into the client 101 and/or receiving user interface data over the network 105 from the server 103. The user interface 201 generates one or more display images 208, as shown in FIG. 7, for example.

The data input device 204 provides input data 207 to the display processor 205 in response to receiving input information either manually from a user or automatically from an electronic device. For example, the data input device 204 is a keyboard and a mouse, but also may be a touch screen, or a microphone with a voice recognition application, for example.

The display processor 205 generates display data, representing one or more images 208 for display, in response to receiving the input data 207 or other data from the server 103, such as the user interface data. The display processor 205 is a known element including electronic circuitry or software or a combination of both for generating display images 208 or portions thereof. The image 208 for display may include any information stored in the memory 203 and/or any information described herein. An action by a user, such as, for example, an activation of a displayed button, may cause the image 208 to be displayed.

The data output device 206 represents any type of element that reproduces data for access by a user. For example, the data output device 206 is a display that generates display images, as shown in FIG. 7, in response to receiving the display signals, but also may be a speaker or a printer, for example.

The user interface 201 provides a graphical user interface (GUI), as shown in FIG. 7, for example.

In the memory 203, the browser application 209 (i.e., “web browser”) is a software application (i.e., function or program) used to locate and display Web pages. Examples of browsers include Netscape® Navigator® and Microsoft® Internet Explorer®. Both of these browsers are graphical browsers, which means that they can display graphics as well as text. The browser may present multimedia information, including sound and video, though it may require plug-ins for some formats.

In the browser application 209, the applet application 210 is an executable application (i.e., function or program) executed from within another application, such as the browser 209, for example. The applet sets the credential information 216 in the browser 209. Typically, applets cannot be executed directly from the operating system of the client 101 and are suitable for small Internet applications accessible from the browser 209. Applets are small in file size, cross-platform compatible, and highly secure (i.e., they can't be used to access users' hard drives). Usually, the applet 210 is a small Java® program that can be embedded in a hyper-text markup language (HTML) Web page that are downloaded to the browser 209 when the browser 209 accesses the Web page. Applets differ from full-fledged Java applications in that they are not allowed to access certain resources on the local computer, such as files and serial devices (modems, printers, etc.), and are prohibited from communicating with most other computers across a network. A common rule is that an applet can only make an Internet connection to the computer from which the applet was sent. The browser 209, which may be equipped with Java virtual machines, can interpret applets from Web servers.

As an alternative to the applet 210, the server 103 may download an ActiveX control to the browser 209. ActiveX is a loosely defined set of technologies developed by Microsoft Corp. for sharing information among different applications. ActiveX is an outgrowth of two other Microsoft technologies called Object Linking and Embedding (OLE) and Component Object Model (COM). ActiveX applies to a whole set of COM-based technologies. ActiveX controls represent a specific way of implementing ActiveX technologies.

An ActiveX control is automatically downloaded and executed by the browser 209. ActiveX is not a programming language, but rather a set of rules for how applications should share information. Programmers can develop ActiveX controls in a variety of languages, including C, C++, Visual Basic, and Java.

An ActiveX control is similar to a Java applet. Unlike Java applets, however, ActiveX controls have full access to the Windows® operating system. This gives ActiveX controls more power than Java applets, but with this power comes a certain risk that the ActiveX controls may damage software or data on the client 101. To control this risk, Microsoft developed a registration system so that the browser 209 can identify and authenticate an ActiveX control before downloading it. Another difference between Java applets and ActiveX controls is that Java applets can be written to run on multiple platforms, whereas ActiveX controls are currently limited to Windows environments.

As an alternative to the applet 210 and ActiveX controls, the server 103 may use a scripting language (e.g., Visual Basic Script (VBScript) or JavaScript) that enables Web authors to embed interactive elements in HTML documents. Hence, the server 103 may download to the client 101 an enabling function in a variety of forms, such as for example, an applet, an ActiveX control, and a script to implement the advantages of the present invention.

In the server 103, the processor 211 exchanges data with the client 101, and exchanges memory data 223 with the memory repository 212. The processor 211 performs tasks in response to processing an object. An object comprises a grouping of data and/or executable instructions, an executable procedure, or the second executable application 107.

The communication processor 213 represents a of communication interface that establishes communication links, by sending and/or receiving a signal, such as data, with multiple different devices via the network 105, otherwise called a communication path, a link, a channel, or a connection. The communication processor 213 establishes communications over a wired or wireless network 105 using communication protocol data stored in the repository 212.

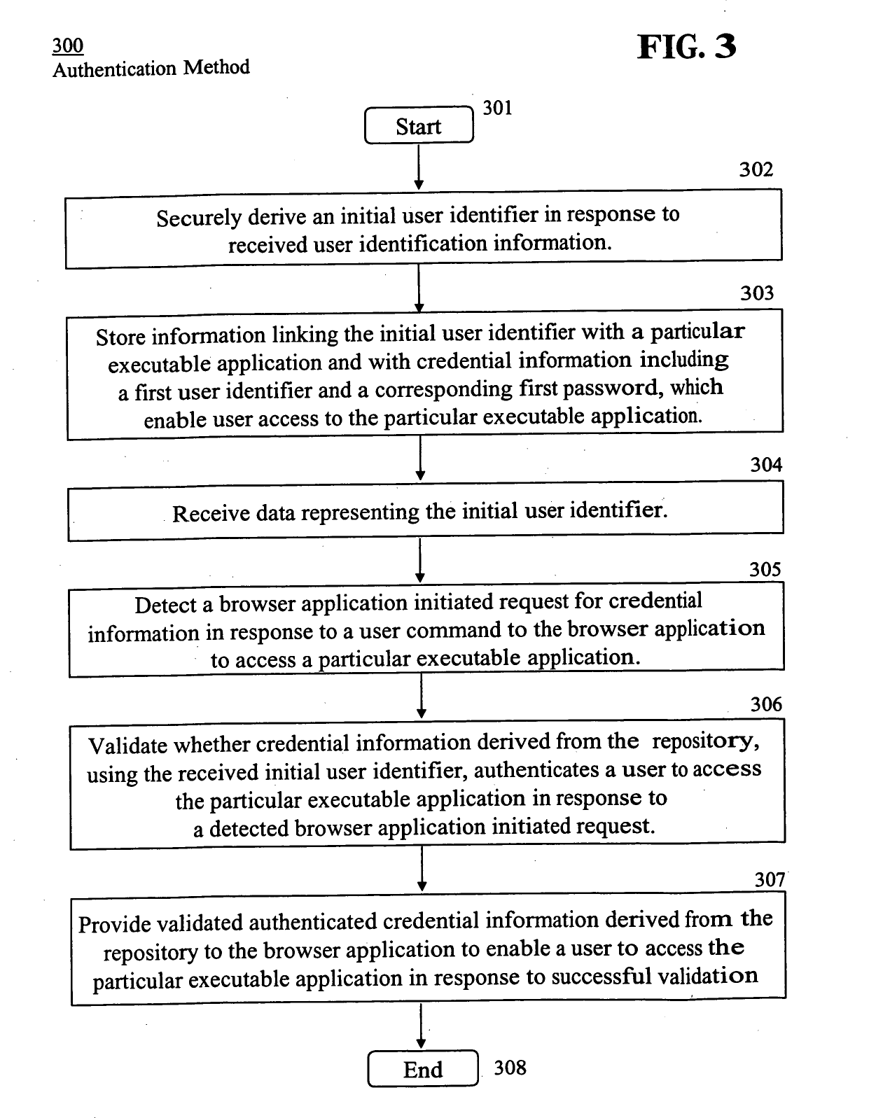

The authentication processor 214 performs method 300 in FIG. 3. The authentication processor 214 may be represented by one processor or by more than one processor, such as for example, a first authentication processor performing steps 302 and 303, and a second authentication processor performing steps 304 to 307.

The context processor 215 securely derives the initial user identifier 217 from the data received by the authentication processor 214. The context processor 215 securely derives the initial user identifier 217 using a securely generated session identifier identifying a particular session of user operation and usage of computer resources.

The repository 212 represents a data storage element and may include a storage device, a database, a memory device, cache, etc. The repository associates the initial user identifier 217 with the second executable application 107 and with the credential information 216, as described with reference to step 303 of FIG. 3. The repository may also associate another initial user identifier with another executable application in the second server 103 and with other credential information 216. The credential information 216 is maintained in a non-secured area of the repository 212 so that authentication is not needed to access the repository 212.

In particular, a cache is a special high-speed storage mechanism. Cache can be either a reserved section of main memory or an independent high-speed storage device. When data is found in the cache, it is called a cache hit, and the effectiveness of a cache is judged by its hit rate. Many cache systems use a technique known as smart caching, in which the system can recognize certain types of frequently used data.

The repository 212 for the cache may be an existing database in existing infrastructure to provide the existing infrastructure with the advantages described herein. This includes the database connection pooling and the resource inventory data store for managing the user account and password to access the database. Additional configuration information is not required. The following table lists the columns to be added to the existing database in the server 103.

| Column Name | Type | Size | NULLs | Default | Key |
|---|---|---|---|---|---|
| Datamode | varchar | 255 | No | N/A | Yes |
| GsmUserId | varchar | 255 | No | N/A | Yes |
| UserId | varchar | 255 | No | N/A | No |
| Password | varchar | 255 | No | N/A | No |

Other fields in the table may include, for example, biometric, genomic, DNA, or other user identification information.

The credential information 216 represents any information that identifies a user. A user may be identified by who they are (e.g., biometric information 221, such as finger print or retinal scan), what they have (e.g., secure object information 222, such as an identification card or radio frequency identification tag), or what they know (e.g., credentials, such as user identifier 219 (e.g., user name) and/or a user password 220). The user identifier 219 and user password 220 may be in any form including, for example, letter, numbers, symbols, and the like. HTTP basic authentication over the Internet uses a user name and a user password.

The second executable application 107 represents one or more software applications, programs, or functions, which control the operation of the system 100 according to predefined instructions. An executable application comprises code or machine readable instruction for implementing predetermined functions including those of an operating system, healthcare information system, or other information processing system, for example, in response user command or input. The repository 212 also includes system software (not shown) that consists of low-level programs that interact with the computer at a very basic level, and includes operating systems, compilers, and utilities for managing computer resources.

The initial user identifier 217 represents an identity of the user that is known by the first server 107. The initial user identifier 217 may be in any form including, for example, any of the forms of the credential information 216.

The files 218 support user access to multiple different executable applications by one or more different users. An individual file in the files 218 contains credential information associated with another initial user identifier and with another executable application enabling user access to the other executable application.

The server pages 224 include three new server pages added to a bin directory in the repository 212 and are called, for example, GsmChild.asp, TestCredential.asp, and SetCredential.asp. The three new server pages support the method and sequence diagrams described with reference to FIGS. 3 to 6.

FIG. 3 illustrates an authentication method 300 (“method”) for the system 100, as shown in FIG. 1.

At step 301, the method 300 starts.

At step 302, the authentication processor 214 securely derives an initial user identifier 217 in response to receiving user identification information. The authentication processor 214 securely derives the initial user identifier using a securely generated session identifier identifying a particular session of user operation and usage of computer resources.

At step 303, the authentication processor 214 stores information linking the initial user identifier 217 with a particular executable application 107 and with credential information 216, including a first user identifier 219 and a corresponding first password 220, which enable user access to the particular executable application 107.

At step 304, the authentication processor 214 receives data representing the initial user identifier 217.

At step 305, the authentication processor 214 detects a browser application 209 initiated request for credential information 216 in response to a user command to the browser application 209 to access a particular executable application 107.

At step 306, the authentication processor 214 validates whether credential information 216 derived from the repository 212, using the received initial user identifier 217, authenticates a user to access the particular executable application 107 in response to a detected browser application 209 initiated request.

At step 307, the authentication processor 214 provides validated authenticated credential information 216 derived from the repository 212 to the browser application 209 to enable a user to access the particular executable application 107 in response to successful validation.

At step 308, the method 300 ends.

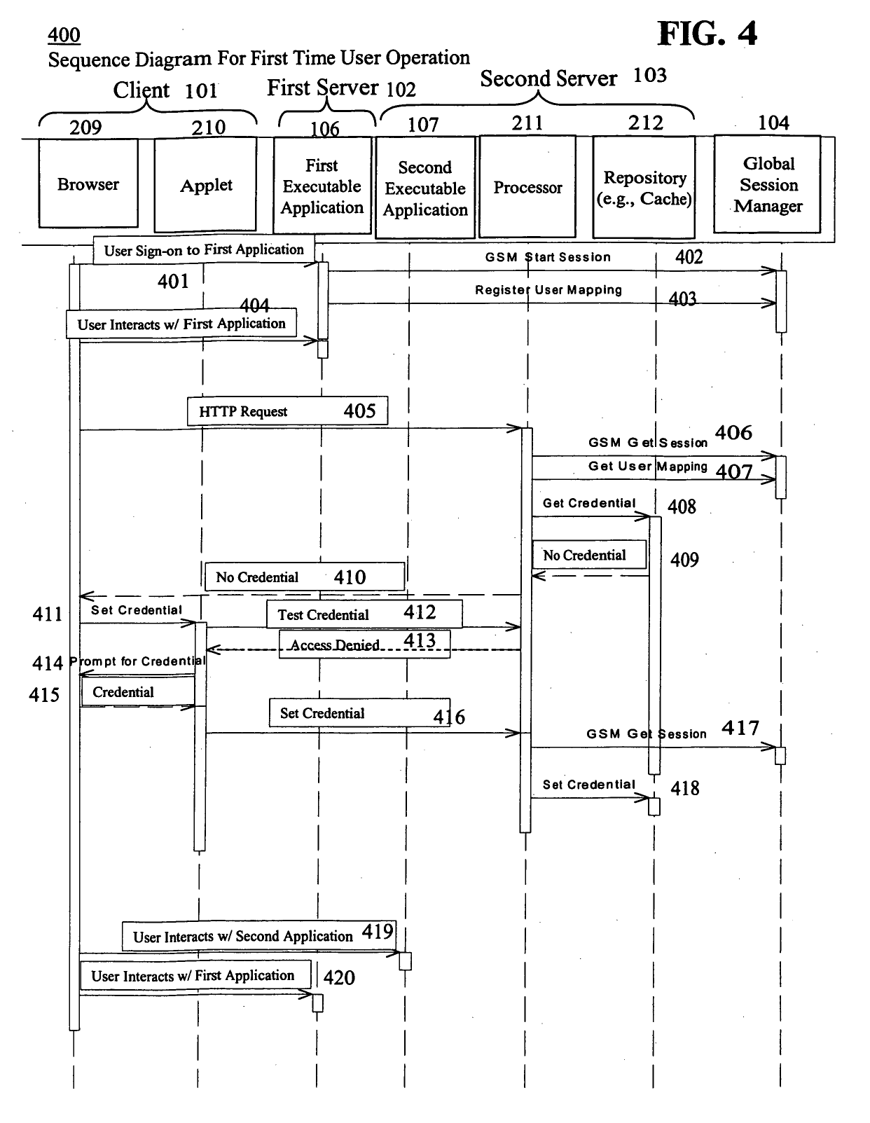

Referring to FIGS. 4, 5, and 6, each one of these figures describes a sequence of steps (i.e., interactions, exchanges, communications, etc.) between or within the client 101, the first server 102, the second server 103, and the manager 104. The client 101 includes the browser 209 and the applet 210. The first server 102 includes the first application 106. The second server 103 includes the second application 107, the processor 211, and the repository 212. The system 100 advantageously integrates the applet 210 and the repository 212 with the other elements shown to support the single sign on methods. A vertical line extending below each of these elements represents the corresponding element. Each horizontal line represents a communication between particular elements, and the direction of the arrow on each horizontal line represents the direction of the communication. The communication represents one or more messages sent between the particular elements.

FIG. 4 illustrates a sequence diagram 400 (“diagram”) for first time user operation of the system 100, as shown in FIG. 1.

At step 401, a user, via the browser 209 in the client 101, signs on to the first application 210 in the first server 106. The user signs on by entering the initial user identifier 217, for example, which is known to the first application 210.

At step 402, the first application 106 communicates a global session manager (“GSM”) start session message to the manager 104. The start session message communicated using a custom, user interface interoperability protocol (“UIIP”) or other protocol. The start session message includes the initial user identifier 217.

At step 403, the first application 106 in the first server 102 communicates a register user-mapping message to the manager 104. The user-mapping message is communicated using the UIIP or other protocol.

At step 404, the browser 209 in the client 101 interacts with the first application 106 in the first server 106. Such interaction may include entering, changing, analyzing, processing, or receiving information, for example. When the system 100 is used by a healthcare organization, the first application 106 may be a clinical application, for example, which includes healthcare information about a patient.

At step 405, the browser 209 in the client 101 communicates a hypertext transfer protocol (HTTP) request to the processor 211 in the second server 103 (e.g. to the GsmChild.asp server page). Such a request may be made from within the first application 106, for example, by clicking on an icon, menu item, or link displayed in the first application 106. The request represents a request to sign on to and interact with a second application in a new instance of the browser 209. When the system 100 is used by a healthcare organization, the second application 107 may be a financial application, for example, which includes financial information about a patient. The request is communicated using the UIIP or other protocol, and retrieves a parameter from a query string to get a session ID.

The request may be formed as a universal resource locator (“URL”) in one of the following formats, for example. The three versions of the URL dictate how the user will view the browser.
1. http://<Soarian Financial Server>/<Financial Information systemvirtual Root>/bin/GsmChild.asp?GSM=<sessionID:encrypted data>&Tab=<initial tab url>

The first URL launches the browser 209 with the user's home page and an initial tab.
2. http://<Soarian Financial Server>/<Financial Information systemVirtual Root>/bin/GsmChild.asp?GSM=<sessionID:encrypted data>&Homepage=<initial tab url>

The second URL launches the browser 209 without the default home page to prevent the user from branching to other tasks.
3. http://<Soarian Financial Server>/<Financial Information systemVirtual Root>/bin/GsmChild.asp?GSM=<sessionID:encrypted data>>

The third URL launches the browser 209 with the default home page and no specific task active.

The first application 210 incorporates the correct Financial Information systemServer>, <Financial Information systemVirtual Root> and the <initial tab url>. The <initial tab url> can either be fully qualified or relative to <Financial Information systemServer>/<Financial Information systemVirtual Root>/html. The first application 210 also creates a separate instance of the browser 209 to be the target of the URL. The separate instance of the browser 209 should be a named window so if the context changes the first application 210 can refresh the window.

Since the GsmChild.asp server page has the potential to change the <Financial Information systemServer> to a fully qualified domain name, the GSM encrypted data is unencrypted, hash changed, and re-encrypted.

At step 406, the processor 211 in the second server 103 communicates a GSM get session message to the manager 104. The get session message is communicated using the UIIP or other protocol.

At step 407, the processor 211 in the second server 103 communicates a get user-mapping message to the manager 104. The user-mapping message is communicated using the UIIP or other protocol.

At step 408, the processor 211 in the second server 103 communicates a get credential message to the repository 212 in the second server 103 to retrieve the user's credential information 216 for the requested session. In the credential information 216, the password 220 is secured, for example, by encryption using an encryption method and a session key. However, for first time user operation, the repository 212 does not store any credential information 216 for the user.

At step 409, the repository 212 in the second server 103 communicates a no credential message to the processor 211 in the second server 103, in response to finding no credential information 216 for the user stored in the repository 212.

At step 410, the processor 211 in the second server 103 communicates a no credential message to the browser 209 in the client 101, in response to finding no credential information 216 for the user stored in the repository 212. The credential information 216 is blank (i.e., zero length strings).

At step 411, the browser 209 in the client 101 communicates a set credential message to the applet 210 in the client 101, using, for example, Microsoft Win32 Internet (WinInet) application program interfaces (APIs). Step 411 ensures that the credential information 216 for the user is set for subsequent HTTP requests from the browser 209 to the web site, thereby eliminating the need to prompt the user for the credential information 216. However, since the repository 212 did not store credential information 216 for the user to be returned in steps 409 and 410, no credential information 216 is set in step 411.

At step 412, the applet 210 in the client 101 communicates a test credential message to the processor 211 in the second server 103 (e.g., to the TestCredential.asp server page), using, for example, Microsoft Win32 Internet (WinInet) application program interfaces (APIs). The test credential message determines whether the credential information 216 is valid or invalid to grant or deny, respectively access to the second application 107.

At step 413, the processor 211 in the second server 103 communicates an access denied message (e.g., http status of 401) to the applet 210 in the client 101, in response to finding no credential information 216 for the user stored in the repository 212.

At step 414, the applet 210 in the client 101 communicates a prompt for credential message to the browser 209 in the client 101. The processor 211 (e.g., the authentication processor 214) initiates prompting of a user to enter credential information by one or more of the following: (a) initiating generation of data representing a menu prompt for display to a user requesting entry of credential information, and (b) directing the web browser 209 to initiate generation of data representing a menu prompt for display to a user requesting entry of credential information. The user may enter the credential information 216 using the conventional dialog window for HTTP basic authentication, for example, as shown in FIG. 7. If the user enters the incorrect credential information 216, then the server will repeat step 413 up to two more times (i.e., the user has three tries to enter the correct information).

At step 415, the browser 209 in the client 101 communicates a credential message, having the credential information 216, to the applet 210 in the client 101.

At step 416, the applet 210 in the client 101 communicates a set credential message to the processor 211 in the second server 103 (e.g., to the SetCredential.asp server page) to update the repository 216 with the entered credential information 216. The SetCredential.asp server page queries the request objects server variables for the user identification and the user password. This page also retrieves the GSM Session ID from the query parameter and the entity and data mode from the cache.

At step 417, the processor 211 in the second server 103 communicates a GSM get session message to the manager 104. The GSM get session message is communicated using the UIIP or other protocol.

At step 418, the processor 211 in the second server 103 communicates a set credential message to the repository 212 in the second server 103. Upon successful completion of the set credential method, the processor 211 redirects the browser to the second application 107.

At step 419, the browser 209 in the client 101 interacts with the second application 107 in the second server 103, via a new instance of the browser 209, in response to storing and/or validating the credential information 216 for the user in the repository 212. After the user completes a task in the second application 107, the user may close the instance of the browser 209 for the second application 107, while keeping open the instance of the browser 209 for the first application 106. At another time, if the credential information 216 identifying the user for the second application 107 remains valid in the repository 212, then the user will be permitted to open the second application without re-entering the credential information 216 identifying the user for the second application 107. Hence, the user's workflow is not interrupted with a sign-on process when requesting access to the second application 107.

At step 420, the browser 209 in the client 101 interacts with the first application 106 in the first server 102. Hence, the system 100 permits the user to interact with the first application 106 in the first server 102 and the second application 107 in the second server 103, after the user is signed on to each application.

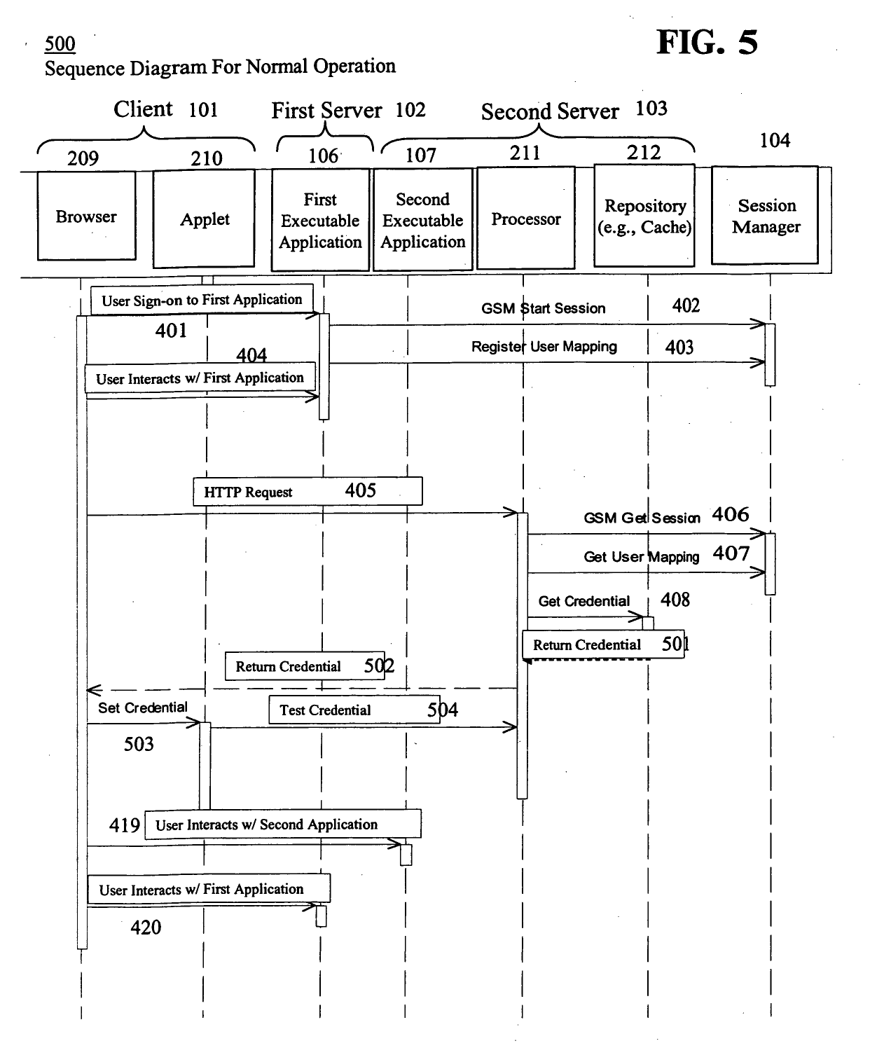

FIG. 5 illustrates a sequence diagram 500 for normal operation of the system 100, as shown in FIG. 1. In FIG. 5, steps 401 to 408, 419, and 420 are the same as shown and described in FIG. 4.

At step 501, the repository 212 in the second server communicates a return credential message to the processor 211 in the second server 103. The return credential message includes a routine that decrypts the password (e.g., using a window onLoad event).

At step 502, the processor 211 in the second server 103 communicates a return credential message (e.g., HTTP 200 status message) to the browser 209 in the client 101 to call the applet 210 set credential method.

At step 503, the browser 209 in the client 101 communicates a set credential message to the applet 210 in the client 101, as in step 411 in FIG. 4.

At step 504, the applet 210 in the client 101 communicates a test credential message to the processor 211 in the second server 103, as in step 412 in FIG. 4.

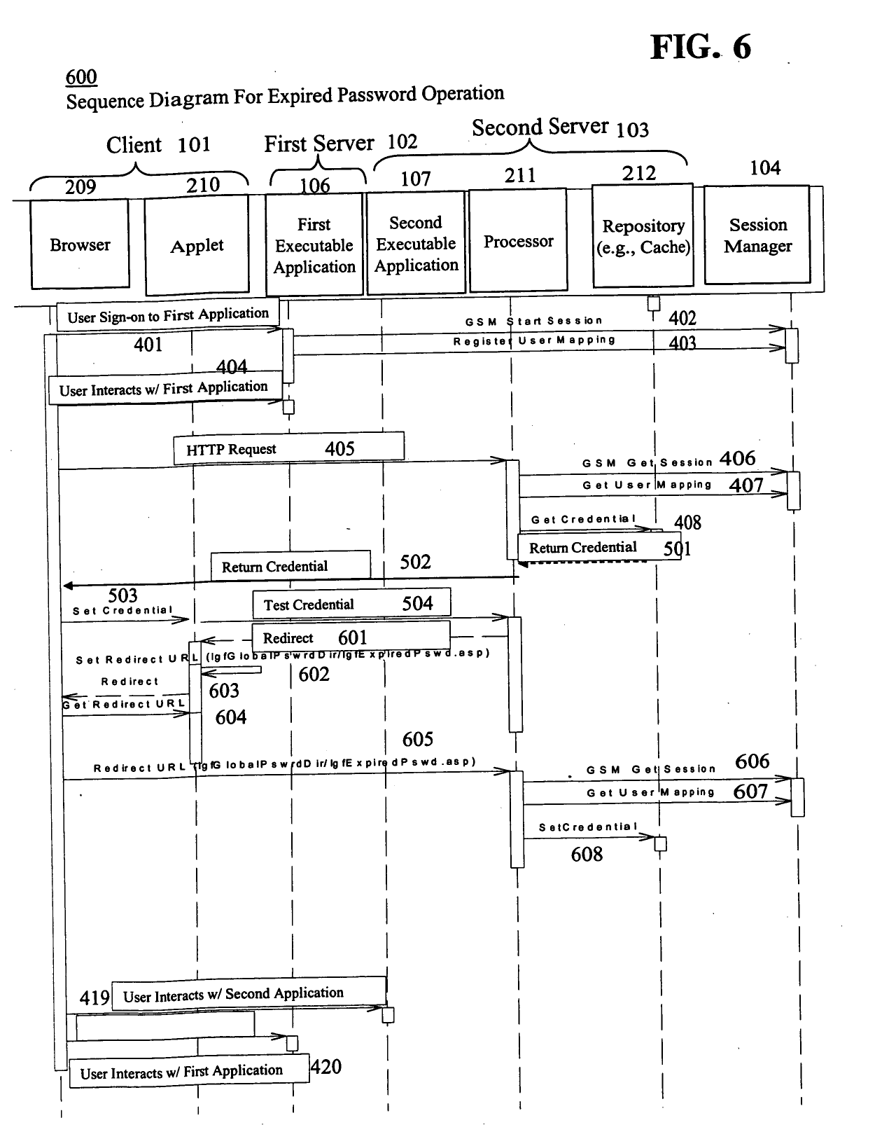

FIG. 6 illustrates a sequence diagram 600 for expired password operation of the system 100, as shown in FIG. 1. In FIG. 6, steps 401 to 408, 419, and 420 are the same as shown and described in FIG. 4, and steps 501 to 504 are the same as shown and described in FIG. 5.

At step 601, the processor 211 in the second server 103 communicates a redirect message (e.g., HTTP 302 status message) to the applet 210 in the client 101.

At step 602, the applet 210 in the client 101 communicates a set redirect universal resource locator (“URL”) to the applet 210 in the client 101.

At step 603, the applet 210 in the client 101 communicates a redirect message to the browser 209 in the client 101. The client 101 displays a window notifying the user that: “Your Password Has Expired.” Upon seeing the window, the user may enter the user identifier 219, the old password, and a new password twice and click “OK” to resume access to the second application 107.

At step 604, the browser 209 in the client 101 communicates a get redirect URL message to the applet 210 in the client 101.

At step 605, the browser 209 in the client 101 communicates a redirect URL to the processor 211 in the second server 103.

At step 606, the processor 211 in the second server 103 communicates a GSM get session message to the manager 104.

At step 607, the processor 211 in the second server 103 communicates a get user mapping message to the manager 104.

At step 608, the processor 211 in the second server 103 communicates a set credential message to the repository 212 in the second server 103.

Likewise, a similar method may be employed for a password 220 that is about to expire but has not yet expired. In this case, the user's password expiration date for the second application 107 is within a time limit for pre-notification of expiration to the user. After step 408, for example, the client 101 displays a window notifying the user that: “Your Password Is About to Expire.” Upon seeing the window, the user may enter the user identifier 219, the old password, and a new password twice and click “OK” to continue having access to the second application 107.

FIG. 7 illustrates an authentication window 700 for the system 100, as shown in FIG. 1. The browser 109 in the client 101 generates the authentication window 700. The authentication window 700 includes a site identification 701, a realm identification 702, a user name box 703, a password box 704, a save password check box 705, an OK button 706, and a cancel button 707. A user of the system 100 enters their user name in the user name box 703 and enters their password in the password box 704 to provide basic HTTP authentication of the user to the system 100.

Hence, while the present invention has been described with reference to various illustrative embodiments thereof, the present invention is not intended that the invention be limited to these specific embodiments. Those skilled in the art will recognize that variations, modifications, and combinations of the disclosed subject matter can be made without departing from the spirit and scope of the invention as set forth in the appended claims.

1. An Internet compatible system for use in authenticating user access to information, comprising:
a repository associating an initial user identifier with a particular executable application and with credential information comprising a first user identifier and a corresponding first password, said first user identifier and said first password enabling user access to said particular executable application; and
an authentication processor for,
receiving data representing said initial user identifier,
detecting a browser application initiated request for credential information in response to a user command to said browser application to access a particular executable application,
validating whether credential information derived from said repository, using said received initial user identifier, authenticates a user to access said particular executable application in response to a detected browser application initiated request, and
providing validated authenticated credential information derived from said repository to said browser application to enable a user to access said particular executable application in response to successful validation.

2. A system according to claim 1, wherein
said repository of credential information is maintained in a non-secured area of memory avoiding the need for authentication to access said repository.

3. A system according to claim 1, including
a context processor for securely deriving said initial user identifier.

4. A system according to claim 3, wherein
said context processor securely derives said initial user identifier using a securely generated session identifier identifying a particular session of user operation and usage of computer resources.

5. A system according to claim 1, wherein
said credential information comprises at least one of, (a) a password, (b) a user identifier, (c) a customer, and (d) biometric information associated with a particular user.

6. A system according to claim 1, wherein
in response to failed validation of said credential information derived from said repository, said authentication processor initiates prompting of a user to enter credential information.

7. A system according to claim 6, wherein
said authentication processor initiates prompting of a user to enter credential information by at least one of, (a) initiating generation of data representing a menu prompt for display to a user requesting entry of credential information, and (b) directing a web browser to initiate generation of data representing a menu prompt for display to a user requesting entry of credential information.

8. A system according to claim 6, wherein
in response to user entry of credentials upon said prompt, said authentication processor updates said repository with said entered credentials.

9. A system according to claim 1, wherein
said authentication processor initiates a new browser instance to enable a user to access said particular executable application in response to successful validation.

10. A system according to claim 1, wherein
said browser application comprises at least one of, (a) a Microsoft® compatible Internet Explorer browser and (b) a Netscape Navigator® compatible browser.

11. A system according to claim 1, wherein
said repository incorporates credential information associated with another initial user identifier with a second executable application enabling user access to a second executable application.

12. A system according to claim 1, wherein
said repository comprises one or more repositories incorporating a plurality of files of information and an individual file of said files contains credential information associated with another initial user identifier and with another executable application enabling user access to said other executable application, said plurality of files supporting user access to a plurality of different executable applications by one or more different users.

13. An Internet compatible system for use in authenticating user access to information, comprising:
a first authentication processor for securely deriving an initial user identifier in response to received user identification information;
a repository associating an initial user identifier with a particular executable application and with credential information comprising a first user identifier and a corresponding first password, said first user identifier and said first password enabling user access to said particular executable application; and
a second authentication processor for,
receiving data representing said initial user identifier,
detecting a browser application initiated request for credential information in response to a user command to said browser application to access a particular executable application,
validating whether credential information derived from said repository, using said received initial user identifier, authenticates a user to access said particular executable application in response to a detected browser application initiated request, and
providing validated authenticated credential information derived from said repository to said browser application to enable a user to access said particular executable application in response to successful validation.

14. A system according to claim 13, wherein
said first authentication processor securely derives said initial user identifier using a securely generated session identifier identifying a particular session of user operation and usage of computer resources.

15. An Internet compatible system for use in authenticating user access to information, comprising:
a first authentication processor for securely deriving an initial user identifier in response to received user identification information;
a repository associating an initial user identifier with a particular executable application and with credential information comprising a first user identifier and a corresponding first password, said first user identifier and said first password enabling user access to said particular executable application; and
a second authentication processor for,
receiving data representing said initial user identifier,
detecting a browser application initiated request for credential information in response to a user command to said browser application to access a particular executable application,
validating whether credential information derived from said repository, using said received initial user identifier, authenticates a user to access said particular executable application in response to a detected browser application initiated request and in response to failed validation of said credential information derived from said repository, said authentication processor initiates prompting of a user to enter credential information, and
providing validated authenticated credential information derived from said repository to said browser application to enable a user to access said particular executable application in response to successful validation.

16. A method for use in authenticating user access to information in an Internet compatible system, comprising the activities of:
storing information associating an initial user identifier with a particular executable application and with credential information comprising a first user identifier and a corresponding first password, said first user identifier and said first password enabling user access to said particular executable application; and
receiving data representing said initial user identifier;
detecting a browser application initiated request for credential information in response to a user command to said browser application to access a particular executable application;
validating whether credential information derived from said repository, using said received initial user identifier, authenticates a user to access said particular executable application in response to a detected browser application initiated request; and
providing validated authenticated credential information derived from said repository to said browser application to enable a user to access said particular executable application in response to successful validation.

17. An Internet compatible system for use in authenticating user access to information, comprising:
a repository associating an initial user identifier with a particular executable application and with credential information enabling user access to said particular executable application; and
an authentication processor for,
receiving data representing said initial user identifier,
detecting a browser application initiated request for credential information in response to a user command to said browser application to access a particular executable application,
validating whether credential information derived from said repository, using said received initial user identifier, authenticates a user to access said particular executable application in response to a detected browser application initiated request, and
providing validated authenticated credential information derived from said repository to said browser application to enable a user to access said particular executable application in response to successful validation.

18. A system according to claim 17 wherein the credential information further comprises:
a first user identifier and a corresponding first password.
